(19) United States
(12) Patent Application Publication
(10) Pub. No.: US 2024/0391334 A1
(43) Pub. Date: Nov. 28, 2024

(54) CHARGING APPARATUS FOR VEHICLE AND METHOD OF CONTROLLING THE SAME

(71) Applicant: HYUNDAI MOBIS CO., LTD., Seoul (KR)

(72) Inventor: Tae Hee LEE, Yongin-si (KR)

(73) Assignee: HYUNDAI MOBIS CO., LTD., Seoul (KR)

(21) Appl. No.: 18/436,460

(22) Filed: Feb. 8, 2024

(30) Foreign Application Priority Data
May 23, 2023 (KR) 10-2023-0066253
Jun. 1, 2023 (KR) 10-2023-0070933

(51) Int. Cl. B60L 53/22; B60L 53/12; B60L 53/38; H01F 38/14; H02J 7/06; H02J 50/12; H02J 50/70; H02M 3/335

(52) U.S. Cl. CPC B60L 53/22; B60L 53/12; B60L 53/38; H01F 38/14; H02J 7/06; H02J 50/12; H02J 50/70; B60L 2210/10; B60L 2210/30; H02J 2207/20; H02M 3/33573; H02M 3/33576

(57) ABSTRACT

The present disclosure relates to a charging apparatus for a vehicle, the charging apparatus including an on-board charger configured to receive AC power and charge a vehicle battery, a wireless charging module configured to receive wireless power transmitted from a transmitter provided outside a vehicle, and a processor configured to connect the wireless charging module and the on-board charger and convert the wireless power, which is received through the wireless charging module, into battery-charging direct-current power by means of the on-board charger in order to charge the vehicle battery in a wireless manner.

### CROSS-REFERENCE TO RELATED APPLICATION

This application claims priority from and the benefit of Korean Patent Application No. 10-2023-0066253, filed on May 23, 2023 and Korean Patent Application No. 10-2023-0070933, filed on Jun. 1, 2023, which are hereby incorporated by reference for all purposes as if set forth herein.

### BACKGROUND

### Field

Exemplary embodiments of the present disclosure relate to a charging apparatus for a vehicle, which serves to charge an electric vehicle, and a method of controlling the same.

### Discussion of the Background

In general, an electric vehicle includes an on-board charger (OBC) capable of charging a vehicle battery in a wired manner.

Recently, a system (i.e., a wireless charging system) capable of charging a vehicle battery in a wireless manner at the time of charging an electric vehicle has been implemented.

In this case, in order to implement the wireless charging system, a wireless charging receiver (i.e., a device configured to receive wireless power transmitted from a transmitter (not illustrated) provided outside a vehicle, convert the wireless power into battery-charging direct-current power, and charge a vehicle battery) needs to be attached to a lower portion of the vehicle.

However, in case that the wireless charging receiver is additionally provided in the state in which the on-board charger (OBC) is already provided in the electric vehicle, there occur problems in that costs required to manufacture the vehicle are increased, a weight of the vehicle is increased, and energy efficiency is degraded.

Therefore, there is a need for a technology to implement the wireless charging system by using the on-board charger (OBC) already included in the electric vehicle in the related art.

In addition, in the case of the configuration in which the wireless charging receiver is attached to the lower portion of the vehicle and charges the vehicle battery, there is difficulty in that the vehicle needs to be parked so that a wireless power receiving part attached to the lower portion of the vehicle and a wireless power transmitter of a wireless power transmitting device installed on a floor in a parking zone are aligned at an exact position. In addition, foreign substances (e.g., leaves, rocks, trash, animals, etc.) are highly likely to be accumulated on an upper portion of the wireless power transmitter of the wireless power transmitting device installed on the floor in the parking zone, and the lower portion of the vehicle is not visually recognized during the charging process, which causes a problem in that it is not easy to monitor or cope with a breakdown (e.g., a fire, etc.).

Therefore, there is a need for a technology to implement a wireless charging system capable of performing a wireless charging process by using the on-board charger (OBC) already included in the electric vehicle in the related art, easily and visually monitoring a charging situation, and quickly coping with a breakdown.

The background technology of the present disclosure is disclosed in Korean Patent No. 10-2503054 (Feb. 20, 2023).

### SUMMARY

Various embodiments are directed to a charging apparatus for a vehicle and a method of controlling the same, which are capable of charging an electric vehicle in a combination of wired and wireless manners.

Various embodiments are also directed to a charging apparatus for a vehicle and a method of controlling the same, which are capable of charging an electric vehicle in a wireless manner through a front or rear bumper.

In an embodiment, a charging apparatus for a vehicle includes: an on-board charger configured to receive AC power and charge a vehicle battery; a wireless charging module configured to receive wireless power transmitted from a transmitter provided outside a vehicle; and a processor configured to connect the wireless charging module and the on-board charger and convert the wireless power, which is received through the wireless charging module, into battery-charging direct-current power by means of the on-board charger in order to charge the vehicle battery in a wireless manner.

In the present disclosure, the wireless charging module may include: a wireless power receiving module that is a constituent element required to receive wireless power and includes a coil or ferrite and a resonance capacitor; and a switch module that is turned on to connect the wireless power receiving module and the on-board charger (OBC) in order to charge the vehicle battery in a wireless manner.

In the present disclosure, the processor may integrally control the on-board charger and the wireless charging module.

In the present disclosure, the on-board charger and the wireless charging module may be connected by a shield cable to cope with electromagnetic interference (EMI) and electromagnetic field (EMF) noise.

In the present disclosure, the switch module may include a relay element or a semiconductor switch element.

In the present disclosure, the processor may turn on a switch module of the wireless charging module, connect a wireless power receiving module to the on-board charger, convert wireless power, which is received through the wireless power receiving module, into battery-charging direct-current power by means of the on-board charger, and output the battery-charging direct-current power to the battery in order to charge the vehicle battery in a wireless manner.

In the present disclosure, the processor may turn off a switch module of the wireless charging module, convert inputted AC power into battery-charging direct-current power by means of the on-board charger, and output the battery-charging direct-current power to the battery in order to charge the vehicle battery in a wired manner.

In the present disclosure, in a DC/DC circuit module having a first converter CONV1 and a second converter CONV2 connected by a transformer TRANS of the on-board charger, the wireless charging module may be connected between the transformer TRANS and the second converter CONV2.

In another embodiment, a charging apparatus for a vehicle includes: an on-board charger configured to receive AC power and charge a vehicle battery; a wireless charging module configured to receive wireless power transmitted from a wireless power transmitting device; and a processor configured to connect the wireless charging module and the on-board charger and convert wireless power, which is received through the wireless charging module, into battery-charging direct-current power by means of the on-board charger to charge the vehicle battery in a wireless manner or configured to selectively convert wireless power, which is received through the wireless charging module, directly into battery-charging direct-current power to charge the vehicle battery in a wireless manner.

In the present disclosure, a wireless power receiving module of the wireless charging module may be coupled to a bracket by means of a fixing member, and the bracket, to which the wireless power receiving module is coupled, may be coupled inside a front or rear bumper of a vehicle by means of the fixing member.

In the present disclosure, the wireless power receiving module may be manufactured through a process in which a coil and a first cover are coupled to manufacture a first step wireless power receiving module, one side of the first step wireless power receiving module may be coupled to a second cover to manufacture a second step wireless power receiving module, and then the other side of the second step wireless power receiving module may be coupled to ferrite to manufacture a final step wireless power receiving module.

In the present disclosure, the processor may integrally control the on-board charger and the wireless charging module.

In the present disclosure, in a DC/DC circuit module having a first converter CONV1 and a second converter CONV2 connected by a transformer TRANS of the on-board charger, the wireless charging module may be connected between the transformer TRANS and the second converter CONV2.

In the present disclosure, the processor may check whether a voltage is detected from the wireless charging module when the vehicle to be charged is completely parked in a parking zone, and when the voltage is detected from the wireless charging module, the processor may control a switch module and connect the wireless charging module, which is attached to the front or rear bumper, to a DC/DC circuit module of the on-board charger to charge the vehicle battery by using wireless power received through the wireless charging module.

In the present disclosure, when the vehicle is completely parked in a parking zone, the wireless power transmitting device may activate a wireless power transmitting module or move the wireless power transmitting module so that the wireless power transmitting module approaches a location positioned at a designated distance from the wireless charging module of the vehicle, and the wireless power transmitting module may transmit wireless power when the wireless power transmitting module is activated or the wireless power transmitting module approaches the location positioned at the designated distance from the wireless charging module of the vehicle.

In the present disclosure, a wireless power transmitting module of the wireless power transmitting device may be implemented to be extended toward and approach a bumper of the vehicle or provided in the form of a barrier rod and implemented to approach the bumper of the vehicle while rotating in a vertical or horizontal direction.

According to the present disclosure, the electric vehicle may be charged in a combination of wired and wireless manners by using the on-board charger (OBC). Therefore, according to the present disclosure, it is possible to prevent increases in costs and weight of the vehicle and improve energy efficiency.

In addition, according to the present disclosure, it is possible to charge the electric vehicle in a wireless manner through the front or rear bumper. Therefore, according to the present disclosure described above, the wireless power receiving part, which is installed on the front or rear bumper of the vehicle, and the wireless power transmitter of the wireless power transmitting device, which is installed in the form of a stand at the front or rear side of the vehicle, may be easily aligned at the exact position. There is little likelihood that foreign substances accumulate on the front side of the wireless power transmitter of the wireless power transmitting device, thereby reducing the probability of a breakdown, easily and visually monitoring the state of charge, and quickly coping with the occurrence of a breakdown.

### BRIEF DESCRIPTION OF THE DRAWINGS

FIG. 1 is an exemplified view illustrating a schematic configuration of a charging apparatus for a vehicle according to a first embodiment of the present disclosure.

FIG. 2 is an exemplified view illustrating a more specific configuration of an on-board charger in FIG. 1.

FIG. 3 is an exemplified view illustrating a more specific configuration of a DC/DC circuit module and a wireless charging module in FIG. 2.

FIG. 4 is a flowchart for explaining a method of controlling the charging apparatus for a vehicle according to the first embodiment of the present disclosure.

FIG. 5 is an exemplified view illustrating a schematic configuration of a charging apparatus for a vehicle according to a second embodiment of the present disclosure.

FIG. 6 is a flowchart for explaining a method of controlling the charging apparatus for a vehicle according to the second embodiment of the present disclosure.

FIG. 7 is a flowchart for explaining an operation of a wireless power transmitting device configured to transmit wireless power to the charging apparatus for a vehicle in FIG. 6.

FIGS. 8A-8C are an exemplified view for explaining a method of performing a wireless charging process through a rear bumper of a vehicle in FIG. 7.

FIG. 9 is an exemplified view illustrating a schematic shape of a wireless charging module attached to a bumper of the vehicle in FIGS. 8A-8C.

FIG. 10 is an exemplified view illustrating a schematic shape of a wireless power receiving module included in the wireless charging module in FIG. 9.

### DETAILED DESCRIPTION OF THE ILLUSTRATED EMBODIMENTS

Hereinafter, a charging apparatus for a vehicle and a method of controlling the same will be described below with reference to the accompanying drawings through various exemplary embodiments.

Here, thicknesses of lines, sizes of constituent elements, or the like illustrated in the drawings, may be exaggerated for clarity and convenience of description. In addition, the terms used below are defined in consideration of the functions in the present disclosure and may vary depending on the intention of a user or an operator or a usual practice. Therefore, such terms should be defined based on the entire contents of the present specification.

### First Embodiment

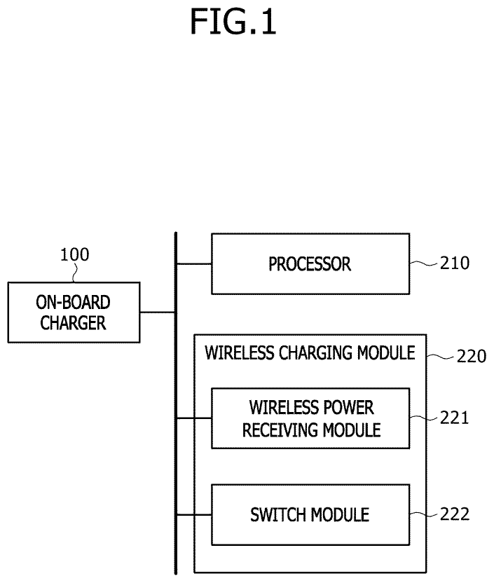

FIG. 1 is an exemplified view illustrating a schematic configuration of a charging apparatus for a vehicle according to a first embodiment of the present disclosure.

With reference to FIG. 1, a charging apparatus for a vehicle according to the present disclosure includes an on-board charger (OBC) 100, a processor 210, and a wireless charging module 220.

In this case, unlike a wireless charging receiver (i.e., a device that includes all a coil (ferrite), a resonance capacitor, a rectifier, a filter, a controller, and the like, independently receives wireless power transmitted from a transmitter (not illustrated) provided outside a vehicle, converts the wireless power into battery-charging direct-current power, and outputs the battery-charging direct-current power to a battery) in the related art, the wireless charging module 220 includes only some constituent elements (e.g., a coil (ferrite) and a resonance capacitor) required to receive wireless power transmitted from a transmitter (not illustrated) provided outside the vehicle.

Therefore, the wireless charging module 220 cannot independently output battery-charging direct-current power. In the present embodiment, the wireless charging module 220 is connected to the on-board charger (OBC) 100, such that the wireless charging module 220 receives wireless power transmitted from the transmitter (not illustrated) provided outside the vehicle, converts the wireless power into battery-charging direct-current power by means of the on-board charger (OBC) 100, and outputs the battery-charging direct-current power to the battery.

The processor 210 integrally controls the on-board charger (OBC) 100 and the wireless charging module 220. That is, the single processor 210 integrally controls the on-board charger (OBC) 100 and the wireless charging module 220 even without a dedicated processor for controlling the wireless charging module 220. The processor 210 according to an exemplary embodiment of the present disclosure may be a hardware device implemented by various electronic circuits (e.g., computer, microprocessor, CPU, ASIC, circuitry, logic circuits, etc.). The processor 210 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor 210 may be implemented as a single integrated semiconductor circuit. The processor 210 may embody one or more processor(s).

As described above, the wireless charging module 220 including only some constituent elements (e.g., a coil (ferrite) and a resonance capacitor) required to receive wireless power transmitted from the transmitter (not illustrated) provided outside the vehicle is implemented by using the single processor 210 and the on-board charger (OBC) 100, such that the present disclosure has effects of preventing increases in costs and weight of the vehicle and improving energy efficiency.

In this case, the on-board charger (OBC) 100 and the wireless charging module 220 are connected by a shield cable to cope with electromagnetic interference (EMI) and electromagnetic field (EMF) noise.

Meanwhile, the wireless charging module 220 includes a wireless power receiving module 221 and a switch module 222.

The wireless power receiving module 221 includes some constituent elements (e.g., the coil (ferrite) and the resonance capacitor) required to receive wireless power transmitted from the transmitter (not illustrated) provided outside the vehicle.

In order to charge the vehicle battery in a wireless manner, the switch module 222 is turned on under the control of the processor 210 and connects the wireless power receiving module 221 and the on-board charger (OBC) 100.

For example, in the present embodiment, the switch module 222 may include a relay element, but the present disclosure is not limited thereto. For example, the switch module 222 may include a semiconductor switch element.

As the wireless power receiving module 221 and the on-board charger (OBC) 100 are connected, the wireless power receiving module 221 receives wireless power transmitted from the transmitter (not illustrated) provided outside the vehicle, converts the wireless power into battery-charging direct-current power by means of the on-board charger (OBC) 100, and outputs the battery-charging direct-current power to the battery.

In case that the vehicle battery is charged in a wireless manner (e.g., a voltage is detected through the wireless power receiving module 221), the processor 210 turns on the switch module 222 and connects the wireless power receiving module 221 and the on-board charger (OBC) 100 to convert wireless power, which is received through the wireless power receiving module 221, into battery-charging direct-current power by means of the on-board charger (OBC) 100 and output the battery-charging direct-current power to the battery.

In addition, in case that the vehicle battery is charged in a wired manner, the processor 210 turns off the switch module 222 to convert AC power into battery-charging direct-current power by means of the on-board charger (OBC) 100 and output the battery-charging direct-current power to the battery.

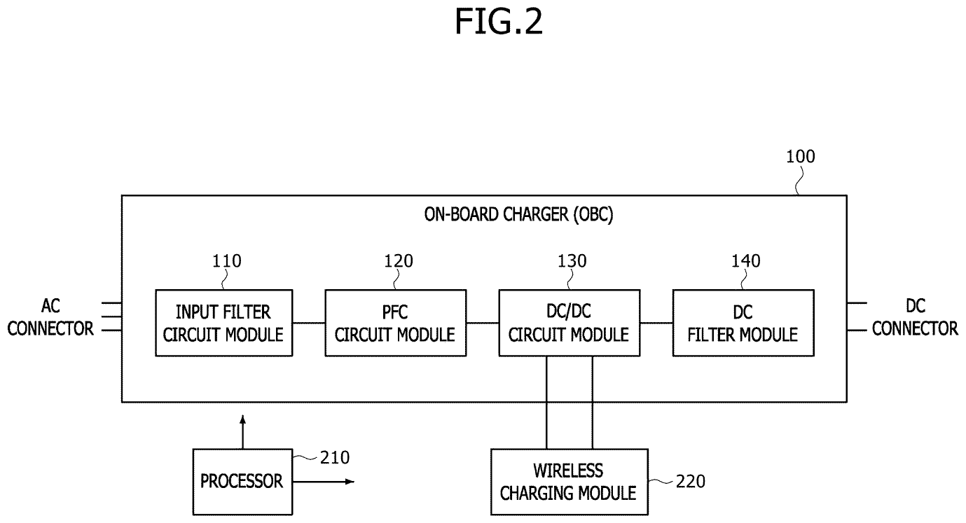

FIG. 2 is an exemplified view illustrating a more specific configuration of the on-board charger (OBC) 100 in FIG. 1. The wireless power receiving module 221 is connected to a DC/DC circuit module 130.

As described above, the on-board charger (OBC) 100 and the wireless charging module 220 are connected by the shield cable to cope with electromagnetic interference (EMI) and electromagnetic field (EMF) noise.

With reference to FIG. 2, when AC power (i.e., alternating current power) is inputted through an AC connector, the on-board charger (OBC) 100 outputs alternating current power from which noise is removed by an input filter circuit module 110, a power fact correction (PFC) circuit module 120 rectifies the alternating current power, from which noise is removed, and outputs direct current power, the DC/DC circuit module 130 converts the rectified direct current power into direct current power at a level suitable for charging the battery and outputs the direct current power, and a DC filter module 140 removes noise from the direct current power converted to the level suitable for charging the battery and outputs the direct current power through a DC connector.

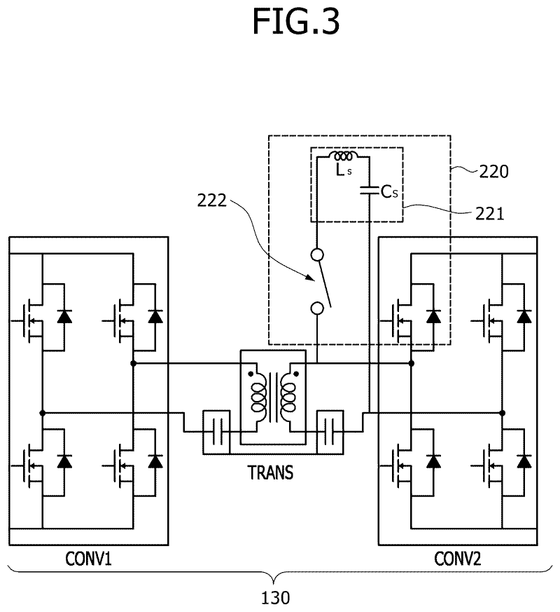

FIG. 3 is an exemplified view illustrating more specific configurations of the DC/DC circuit module 130 and the wireless charging module 220 in FIG. 2. A first converter CONV1 and a second converter CONV2 of the DC/DC circuit module 130 are connected through a transformer TRANS, and the wireless charging module 220 is connected between the transformer TRANS and the second converter CONV2 to convert wireless power, which is received through the wireless power receiving module 221, into direct current power at a level suitable for charging the battery by means of the second converter CONV2 of the on-board charger (OBC) 100 and output the direct current power.

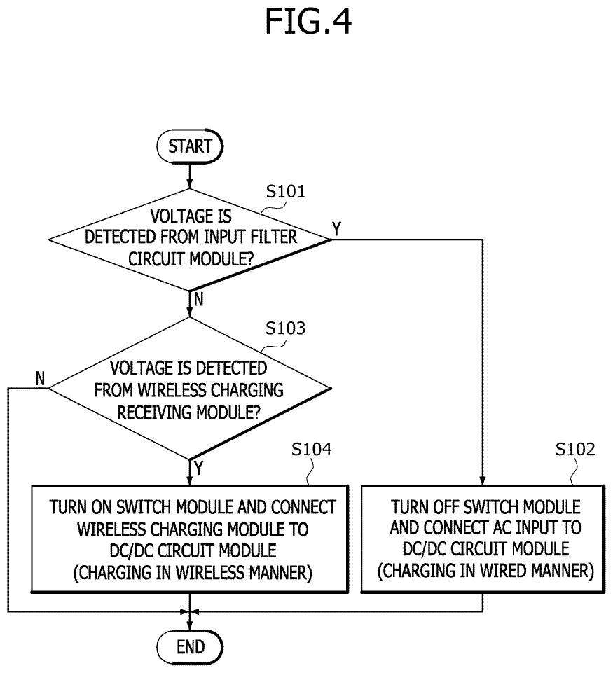

FIG. 4 is a flowchart for explaining a method of controlling the charging apparatus for a vehicle according to the embodiment of the present disclosure.

With reference to FIG. 4, the processor 210 checks whether a voltage is detected from the input filter circuit module 110 (S101) and checks whether a voltage is detected from the wireless charging module 220 (S102).

For example, when AC power (alternating current power) is inputted through the AC connector to charge the vehicle battery in a wired manner by means of the on-board charger (OBC) 100, a voltage is detected through the input filter circuit module 110.

However, in another embodiment, an input of AC power (alternating current power) may be detected by another constituent element or a sensor instead of the input filter circuit module 110.

In the checking step (S101), the processor 210 detects whether the vehicle battery is intended to be charged in a wired manner by means of the on-board charger (OBC) 100.

When the AC power (alternating current power) is inputted through the AC connector to charge the vehicle battery in a wired manner by means of the on-board charger (OBC) 100 (YES in S101), the processor 210 performs control to turn off the switch module 222 and connects an AC input to the DC/DC circuit module 130 (S102), thereby charging the vehicle battery in a wired manner.

Meanwhile, when AC power (alternating current power) is not inputted through the AC connector (NO in S101) and a voltage is detected from the wireless charging module 220 (YES in S103), the processor 210 performs control to turn on the switch module 222 and connects the wireless charging module 220 to the DC/DC circuit module 130 (S104), thereby charging the vehicle battery in a wireless manner.

Meanwhile, although not specifically illustrated in the drawings, the vehicle battery may be charged in a wired manner in case that voltages are detected from both the input filter circuit module 110 and the wireless charging module 220.

According to the present disclosure described above, the electric vehicle may be charged in a combination of wired and wireless manners by using the on-board charger (OBC), which may prevent increases in costs and weight of the vehicle and improve energy efficiency.

### Second Embodiment

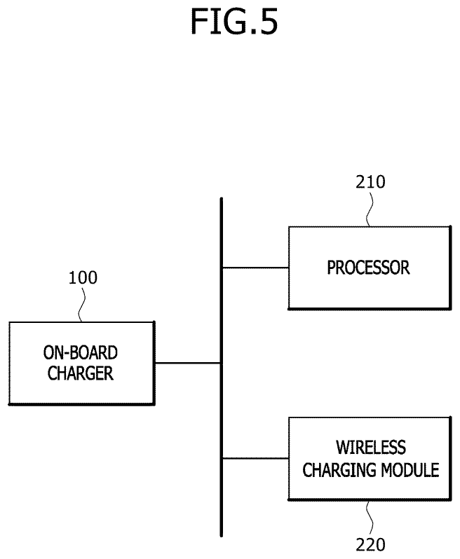

FIG. 5 is an exemplified view illustrating a schematic configuration of a charging apparatus for a vehicle according to a second embodiment of the present disclosure.

With reference to FIG. 5, a charging apparatus for a vehicle according to the present disclosure includes the on-board charger (OBC) 100, the processor 210, and the wireless charging module 220.

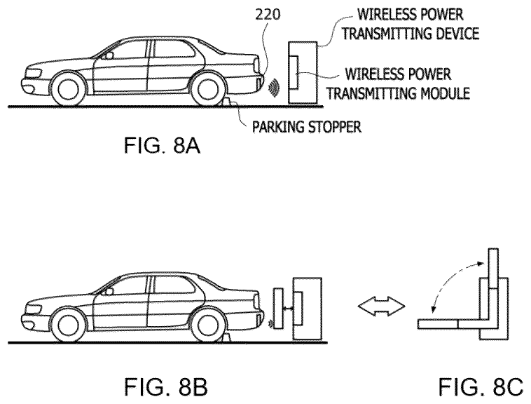

In this case, the wireless charging module 220 may be implemented in the same way as a wireless charging receiver (i.e., a device that includes all a coil (ferrite), a resonance capacitor, a rectifier, a filter, a controller, and the like, independently receives wireless power transmitted from a transmitter (not illustrated) provided outside a vehicle, converts the wireless power into battery-charging direct-current power, and outputs the battery-charging direct-current power to a battery) in the related art. Alternatively, the wireless charging module 220 may include only some constituent elements (e.g., a coil (ferrite) and a resonance capacitor) required to receive wireless power transmitted from a wireless power transmitter (i.e., the wireless power transmitting device in FIGS. 8A-8C) provided outside the vehicle.

Therefore, the wireless charging module 220 may be implemented to independently output battery-charging direct-current power. Alternatively, the wireless charging module 220 may be connected to the on-board charger (OBC) 100, such that the wireless charging module 220 may be implemented to receive wireless power transmitted from the transmitter (i.e., the wireless power transmitting device in FIGS. 8A-8C) provided outside the vehicle, convert the wireless power into battery-charging direct-current power by means of the on-board charger (OBC) 100, and output the battery-charging direct-current power to the battery.

The processor 210 may integrally control the on-board charger (OBC) 100 and the wireless charging module 220. That is, the single processor 210 may integrally control the on-board charger (OBC) 100 and the wireless charging module 220 even without a dedicated processor for controlling the wireless charging module 220.

As described above, the wireless charging module 220 including only some constituent elements (e.g., a coil (ferrite) and a resonance capacitor) required to receive wireless power transmitted from the transmitter (i.e., the wireless power transmitting device in FIGS. 8A-8C) provided outside the vehicle is implemented by using the single processor 210 and the on-board charger (OBC) 100, such that the present disclosure may have effects of preventing increases in costs and weight of the vehicle and improving energy efficiency.

In this case, the on-board charger (OBC) 100 and the wireless charging module 220 are connected by a shield cable to cope with electromagnetic interference (EMI) and electromagnetic field (EMF) noise.

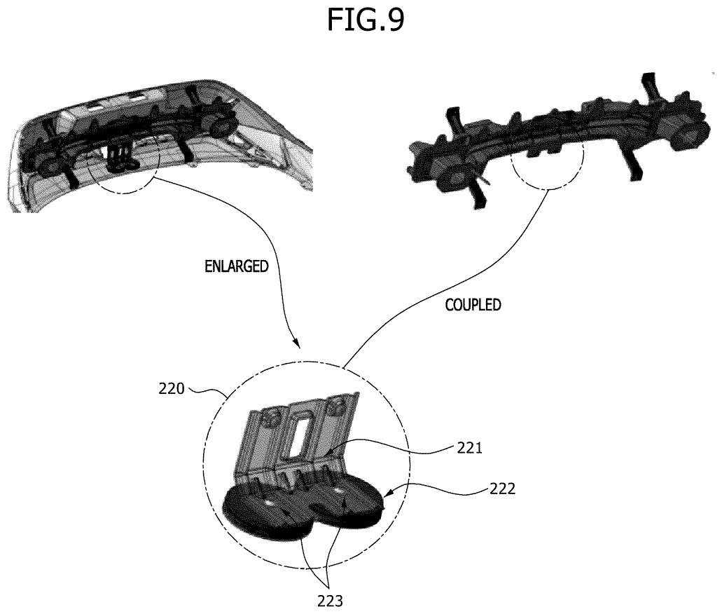

In the present embodiment, as illustrated in FIGS. 8 and 9, the wireless charging module 220 may be attached to a bumper (e.g., a front or rear bumper) of the vehicle.

Meanwhile, although not specifically illustrated in the drawings, the wireless charging module 220 may include a wireless power receiving module (not illustrated) and a switch module (not illustrated).

The wireless power receiving module (not illustrated) may include some constituent elements (e.g., the coil (ferrite) and the resonance capacitor) required to receive wireless power transmitted from the transmitter (i.e., the wireless power transmitting device in FIGS. 8A-8C) provided outside the vehicle.

In addition, in order to charge the vehicle battery in a wireless manner, the switch module (not illustrated) may be turned on under the control of the processor 210 and connect the wireless power receiving module (not illustrated) and the on-board charger (OBC) 100.

In this case, in the present embodiment, the switch module (not illustrated) may include a relay element, but the present disclosure is not limited thereto. For example, the switch module (not illustrated) may include a semiconductor switch element.

Therefore, as the wireless power receiving module (not illustrated) and the on-board charger (OBC) 100 are connected, the wireless power receiving module (not illustrated) may receive wireless power transmitted from the transmitter (i.e., the wireless power transmitting device in FIGS. 8A-8C) provided outside the vehicle, convert the wireless power into battery-charging direct-current power by means of the on-board charger (OBC) 100, and output the battery-charging direct-current power to the battery.

In case that the vehicle battery is charged in a wireless manner (e.g., a voltage is detected through the wireless power receiving module (not illustrated)), the processor 210 may turn on the switch module (not illustrated) and connect the wireless power receiving module (not illustrated) and the on-board charger (OBC) 100 to convert wireless power, which is received through the wireless power receiving module (not illustrated), into battery-charging direct-current power by means of the on-board charger (OBC) 100 and output the battery-charging direct-current power to the battery.

In addition, in case that the vehicle battery is charged in a wired manner, the processor 210 may turn off the switch module (not illustrated) to convert AC power into battery-charging direct-current power by means of the on-board charger (OBC) 100 and output the battery-charging direct-current power to the battery.

In case that the wireless charging module 220 is independently implemented to output the battery-charging direct-current power, the processor 210 may independently charge the battery even without controlling the switch module (not illustrated). Therefore, the description of the present embodiment will be focused on the configuration in which the wireless charging module 220 is connected to the on-board charger (OBC) 100 to receive wireless power transmitted from the transmitter (i.e., the wireless power transmitting device in FIGS. 8A-8C) provided outside the vehicle, convert the wireless power into battery-charging direct-current power by means of the on-board charger (OBC) 100, and output the battery-charging direct-current power to the battery.

Meanwhile, the on-board charger (OBC) 100 is identical to that in the first embodiment, and a specific description thereof will be omitted.

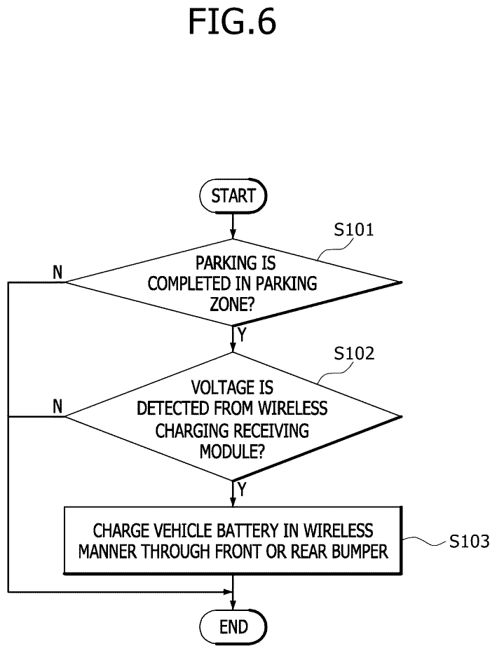

FIG. 6 is a flowchart for explaining a method of controlling the charging apparatus for a vehicle according to the embodiment of the present disclosure.

With reference to FIG. 6, when the parking in the parking zone is completed (YES in S101), the processor 210 checks whether a voltage is detected from the input filter circuit module 110 (e.g., a voltage is detected through the input filter circuit module 110 when AC power (alternating current power) is inputted through the AC connector) or checks whether a voltage is detected from the wireless charging module 220. In case that the voltage is detected from the wireless charging module 220 (YES in S102), the processor 210 may control the switch module (not illustrated) and connect the wireless charging module 220, which is attached to the front or rear bumper, to the DC/DC circuit module 130 to charge the vehicle battery in a wireless manner (S103) (see FIGS. 8A-8C).

Meanwhile, although not illustrated in the drawings, when the AC power (alternating current power) is inputted through the AC connector to charge the vehicle battery in a wired manner by means of the on-board charger (OBC) 100, the processor 210 may control the switch module (not illustrated) and connect the AC input to the DC/DC circuit module 130 to charge the vehicle battery in a wired manner.

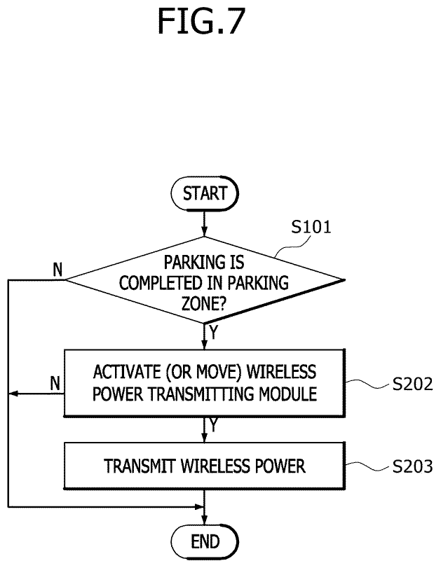

FIG. 7 is a flowchart for explaining an operation of the wireless power transmitting device configured to transmit wireless power to the charging apparatus for a vehicle in FIG. 6, and FIGS. 8A-8C are an exemplified view for explaining a method of performing a wireless charging process through the rear bumper of the vehicle in FIG. 7.

With reference to FIG. 7, when the vehicle is completely parked in the parking zone (YES in S201), the wireless power transmitting device may activate a wireless power transmitting module (or move the wireless power transmitting module so that the wireless power transmitting module approaches a location positioned at a designated distance from the wireless charging module 220 of the vehicle) (S202) (see FIGS. 8B and 8C).

FIG. 8B is an exemplified view illustrating an operation in which the wireless power transmitting module is extended forward (i.e., in a direction toward the bumper of the vehicle) and approaches the bumper, and FIG. 8C is an exemplified view illustrating an operation in which the wireless power transmitting module implemented in the form of a barrier rod is rotated in a vertical or horizontal direction.

When the wireless power transmitting module is activated (or the wireless power transmitting module is moved and approaches the location positioned at the designated distance from the wireless charging module 220 of the vehicle), the wireless power transmitting device may transmit wireless power through the wireless power transmitting module (S203) to charge the vehicle battery in a wireless manner through the front or rear bumper of the vehicle.

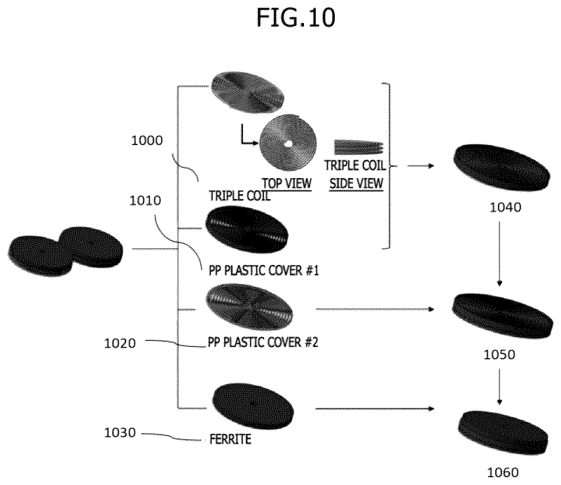

FIG. 9 is an exemplified view illustrating a schematic shape of the wireless charging module attached to the bumper of the vehicle in FIGS. 8A-8C, and FIG. 10 is an exemplified view illustrating a schematic shape of the wireless power receiving module 222 included in the wireless charging module 220 in FIG. 9.

With reference to FIG. 9, the wireless charging module 220 attached to the bumper of the vehicle includes a bracket 221, a wireless power receiving module 222, and fixing members 223.

The wireless power receiving module 222 is coupled to the bracket 221 by means of the fixing members 223, and the bracket 221, to which the wireless power receiving module 222 is coupled, is coupled inside the front or rear bumper of the vehicle by means of the fixing members.

With reference to FIG. 10, the wireless power receiving module 222 is manufactured through a process in which a triple coil 1000 and a first cover (e.g., PP plastic cover #1) 1010 are coupled to manufacture a first step wireless power receiving module 1040, one side of the first step wireless power receiving module 1040 is coupled to a second cover (e.g., PP plastic cover #2) 1020 to manufacture a second step wireless power receiving module 1050, and then the other side of the second step wireless power receiving module 1050 is coupled to ferrite 1030 to manufacture a final step wireless power receiving module 1060.

However, the shape of the wireless charging module 220 described with reference to FIGS. 8A to 10 is illustrated to assist in understanding the present disclosure, and the present disclosure is not limited thereto.

According to the present disclosure described above, the electric vehicle may be charged in a wireless manner through the front or rear bumper. The wireless power receiving part, which is installed on the front or rear bumper of the vehicle, and the wireless power transmitter of the wireless power transmitting device, which is installed in the form of a stand at the front or rear side of the vehicle, may be easily aligned at the exact position. There is little likelihood that foreign substances accumulate on the front side of the wireless power transmitter of the wireless power transmitting device, thereby reducing the probability of a breakdown, easily and visually monitoring the state of charge, and quickly coping with the occurrence of a breakdown.

According to the present disclosure described above, the electric vehicle may be charged in a combination of wired and wireless manners by using the on-board charger (OBC), which may prevent increases in costs and weight of the vehicle and improve energy efficiency.

While the present disclosure has been described with reference to the embodiments depicted in the drawings, the embodiments are for illustrative purposes only, and those skilled in the art to which the present technology pertains will understand that various modifications of the embodiments and any other embodiments equivalent thereto are available. Accordingly, the technical protection scope of the present disclosure should be determined by the appended claims. In addition, the configurations described in the present specification may be implemented as methods or processes, devices, software programs, data stream, or signals. Even though the implementation of the single form is described (e.g., only the method is described), the described features may also be implemented in other forms (e.g., devices or programs). The device may be implemented as appropriate hardware, software, firmware, and the like. For example, the method may be implemented by devices such as processors that generally refer to processing devices including computers, microprocessors, integrated circuits, programmable logic devices, or the like. The processors also include communication devices such as computers, cellular phones, portable/personal information terminals (personal digital assistants (PDA)), and other devices that facilitates information communication with final users.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A charging apparatus for a vehicle, the charging apparatus comprising:
an on-board charger configured to receive AC power and charge a vehicle battery;
a wireless charging module configured to receive wireless power transmitted from a transmitter provided outside a vehicle; and
a processor configured to connect the wireless charging module and the on-board charger and convert the wireless power received through the wireless charging moduleinto battery-charging direct-current power the on-board charger in order to charge the vehicle battery in a wireless manner.

2. The charging apparatus of claim 1, wherein the wireless charging module comprises:
a wireless power receiving module configured to receive wireless power and include a resonance capacitor, the wireless power receiving module comprising a coil or ferrite; and
a switch module configured to connect the wireless power receiving module and the on-board charger in order to charge the vehicle battery in a wireless manner.

3. The charging apparatus of claim 1, wherein the processor integrally controls the on-board charger and the wireless charging module.

4. The charging apparatus of claim 1, wherein the on-board charger and the wireless charging module are connected by a shield cable to cope with electromagnetic interference (EMI) and electromagnetic field (EMF) noise.

5. The charging apparatus of claim 2, wherein the switch module comprises a relay element or a semiconductor switch element.

6. The charging apparatus of claim 1, wherein the processor turns on a switch module of the wireless charging module, connects a wireless power receiving module to the on-board charger, converts wireless power received through the wireless power receiving module into battery-charging direct-current power using the on-board charger, and outputs the battery-charging direct-current power to the battery in order to charge the vehicle battery in a wireless manner.

7. The charging apparatus of claim 1, wherein the processor turns off a switch module of the wireless charging module, converts inputted AC power into battery-charging direct-current power using the on-board charger, and outputs the battery-charging direct-current power to the battery in order to charge the vehicle battery in a wired manner.

8. The charging apparatus of claim 1, wherein in a DC/DC circuit module having a first converter and a second converter connected by a transformer of the on-board charger, the wireless charging module is connected between the transformer and the second converter.

9. A method of controlling a charging apparatus for a vehicle, the method comprising:
determining, by a processor, whether AC power is inputted through an AC connector of an on-board charger and determining whether a voltage is detected from a wireless charging module;
in response to a determination that the AC power is inputted through the AC connector of the on-board charger or a determination that the AC power is inputted through the AC connector of the on-board charger and the voltage is detected from a wireless charging module, turning off, by the processor, a switch module of the wireless charging module and connecting the AC power to a DC/DC circuit module of the on-board charger to charge a vehicle battery in a wired manner when the AC power is inputted to the AC connector through the checking step; and
in response to a determination that the AC power is not inputted through the AC connector of the on-board charger and the voltage is detected from the wireless charging module, turning on, by the processor, the switch module and connecting the wireless charging module to the DC/DC circuit module to charge the vehicle battery in a wireless manner.

10. The method of claim 9,
wherein the turning on, by the processor, the switch module and connecting the wireless charging module to the DC/DC circuit module to charge the vehicle battery in a wireless manner comprising:
converting wireless power received through the wireless power receiving module into battery-charging direct-current power.

11. A charging apparatus for a vehicle, the charging apparatus comprising:
an on-board charger configured to receive AC power and charge a vehicle battery;
a wireless charging module configured to receive wireless power transmitted from a wireless power transmitting device; and
a processor configured to connect the wireless charging module and the on-board charger, the processor configured to convert wireless power received through the wireless charging module directly into battery-charging direct-current power using the on-board charger to charge the vehicle battery in a wireless manner and configured to convert the AC power into battery-charging direct-current power to charge the vehicle battery in a wired manner.

12. The charging apparatus of claim 11, wherein a wireless power receiving module of the wireless charging module is coupled to a bracket by a fixing member, and the bracket, to which the wireless power receiving module is coupled, is coupled inside a front or rear bumper of a vehicle by the fixing member.

13. The charging apparatus of claim 12, wherein the wireless power receiving module is manufactured through a process in which a coil and a first cover are coupled to manufacture a first step wireless power receiving module, one side of the first step wireless power receiving module is coupled to a second cover to manufacture a second step wireless power receiving module, and then the other side of the second step wireless power receiving module is coupled to ferrite to manufacture a final step wireless power receiving module.

14. The charging apparatus of claim 11, wherein the processor integrally controls the on-board charger and the wireless charging module.

15. The charging apparatus of claim 11, wherein in a DC/DC circuit module having a first converter and a second converter connected by a transformer of the on-board charger, the wireless charging module is connected between the transformer and the second converter.

16. The charging apparatus of claim 11, wherein the processor determines if a voltage is detected from the wireless charging module when the vehicle to be charged is completely parked in a parking zone, and
in response to a determination that the voltage is detected from the wireless charging module, the processor controls a switch module and connects the wireless charging module, which is attached to the front or rear bumper, to a DC/DC circuit module of the on-board charger to charge the vehicle battery by using wireless power received through the wireless charging module.

17. The charging apparatus of claim 11, wherein when the vehicle is completely parked in a parking zone, the wireless power transmitting device activates a wireless power transmitting module or moves the wireless power transmitting module so that the wireless power transmitting module approaches a location positioned at a designated distance from the wireless charging module of the vehicle, and
wherein the wireless power transmitting module transmits wireless power when the wireless power transmitting module is activated or the wireless power transmitting module approaches the location positioned at the designated distance from the wireless charging module of the vehicle.

18. The charging apparatus of claim 11, wherein a wireless power transmitting module of the wireless power transmitting device is implemented to be extended toward and approach a bumper of the vehicle or provided in the form of a barrier rod and implemented to approach the bumper of the vehicle while rotating in a vertical or horizontal direction.
